(19) United States
(12) Patent Application Publication
(10) Pub. No.: US 2026/0147134 A1
(43) Pub. Date: May 28, 2026

(54) PULSED NEUTRON METHODS FOR DOWNHOLE FORMATION EVALUATION AND MONITORING OF NATURAL HYDROGEN SOURCE ROCK AND RESERVOIRS

(71) Applicant: Halliburton Energy Services, Inc., Houston, TX (US)

(72) Inventors: Jeffrey Crawford, Houston, TX (US); Glenn Wilson, Houston, TX (US)

(73) Assignee: Halliburton Energy Services, Inc., Houston, TX (US)

(21) Appl. No.: 19/399,123

(22) Filed: Nov. 24, 2025

Related U.S. Application Data
(60) Provisional application No. 63/725,737, filed on Nov. 27, 2024.

(51) Int. Cl. G01V 5/10; E21B 49/00; G01V 5/06

(52) U.S. Cl. CPC G01V 5/102; E21B 49/00; G01V 5/06; E21B 2200/20

(57) ABSTRACT

A method of deploying a pulsed neutron logging tool. The method may comprise detecting natural gamma rays from the subterranean formation via one or more detectors of the pulsed neutron logging tool, broadcasting neutrons into the subterranean formation, and detecting neutron-induced gamma rays and natural gamma rays from the subterranean formation. The method may further comprise creating an inelastic spectrum, a capture spectrum, or a capture time decay from the natural gamma rays or the neutron-induced gamma rays, forming an inelastic yields, a capture elemental yields, or a formation sigma form the inelastic spectrum, the capture spectrum, or the capture time decay, creating a closure model from the inelastic yields and/or capture elemental yields and/or a formation sigma, and identifying a porosity, a mineral weight fraction, or a quality figure of merit from the closure model that quantifies geologic hydrogen reservoir quality.

### BACKGROUND

Demand for hydrogen as both a feedstock to chemical processing and as an energy source is expected to increase dramatically in coming decades. Hydrogen may be produced from a number of sources. The standard processes of producing hydrogen is via steam reformed methane (SMR) with or without carbon capture and storage (commonly referred to as “grey” and “blue” hydrogen, respectively) or via water electrolysis using renewable energy sources (commonly referred to as “green hydrogen”). Recently, there has been interest in evaluating naturally occurring or geologic hydrogen (commonly referred to as “white hydrogen”). Wellbores drilled into subterranean formations may enable the recovery of naturally occurring (or geologic) hydrogen using any number of different techniques.

While many of the formation evaluation and monitoring methods deployed for fossil fuel exploration and production may be leveraged for natural hydrogen exploration and production, there are unique challenges that require the development of new methods. For example, oil and gas exploration and production focuses on sedimentary rocks, while geologic hydrogen exploration and production may be associated with sedimentary, igneous or metamorphic rocks. For example, similar to oil and gas, natural hydrogen may accumulate in structural traps within sedimentary formations. However, natural hydrogen may also accumulate or be stimulated in igneous or metamorphic source rocks. Therefore, methods to characterize the source rock and to evaluate its hydrogen-producing capacity are needed.

Extending beyond resource evaluation (i.e., reserves and resource quantification), there is also a need to evaluate reservoir production performance. In some instances, natural hydrogen resources are depleted from an initial stock, such as an accumulation in structural traps within sedimentary formations. In other instances, natural hydrogen resources may be generated from appropriate stimulation of the reservoir rock, in a manner that the reservoir rock's capacity for generating hydrogen is depleted over time. Thus, there is a need to be able to measure and monitor natural hydrogen-producing rock units.

### BRIEF DESCRIPTION OF THE DRAWINGS

These drawings illustrate certain aspects of some of the embodiments of the present disclosure and should not be used to limit or define the disclosure.

FIG. 1 illustrates a logging while drilling operation utilizing a pulsed neutron logging tool, in accordance with examples of the present disclosure.

FIG. 2 illustrates the pulsed neutron logging tool in a wireline operation, in accordance with examples of the present disclosure.

FIG. 3 is a diagram of illustrative embodiments of a pulsed neutron logging tool.

FIG. 4A-4D are diagrams of alternative embodiments of a pulsed neutron logging tool.

FIG. 5 illustrates the energy of a neutron as it interacts in the present disclosure.

FIG. 6 illustrates a schematic of an information handling system.

FIG. 7 illustrates a schematic of a chip set.

FIG. 8 illustrates a computing network.

FIG. 9 illustrates a neural network.

FIG. 10 illustrates a workflow for geologic hydrogen formation evaluation and monitoring

### DETAILED DESCRIPTION

The present disclosure generally relates to systems and methods for prompt gamma neutron activation analysis for elemental spectroscopy and mineralogy. Prompt neutron-gamma activation analysis involves at least one neutron source and at least one gamma ray detector. The neutron source may be a chemical source, such as an americium-beryllium (AmBe) compound. In other examples, the neutron source may be a neutron generator or a pulsed neutron generator. For example, a pulsed neutron-based system may comprise a pulsed neutron logging tool with at least one pulsed neutron source and at least one gamma detector. During logging operations, the neutrons interact with the elements in a subterranean formation, which then produce characteristic gamma rays. Measuring the gamma rays may allow for three measurement outputs. Specifically, measurement outputs may be an inelastic spectrum, a capture spectrum, and a time decay curve. The two spectra may be decomposed into the elemental constituents, giving relative elemental yields. In addition, The time decay curve may be fit to determine the formation sigma (total capture cross-section). A “closure model” may be employed to convert the relative elemental yields to dry weight fractions, to be discussed in detail below.

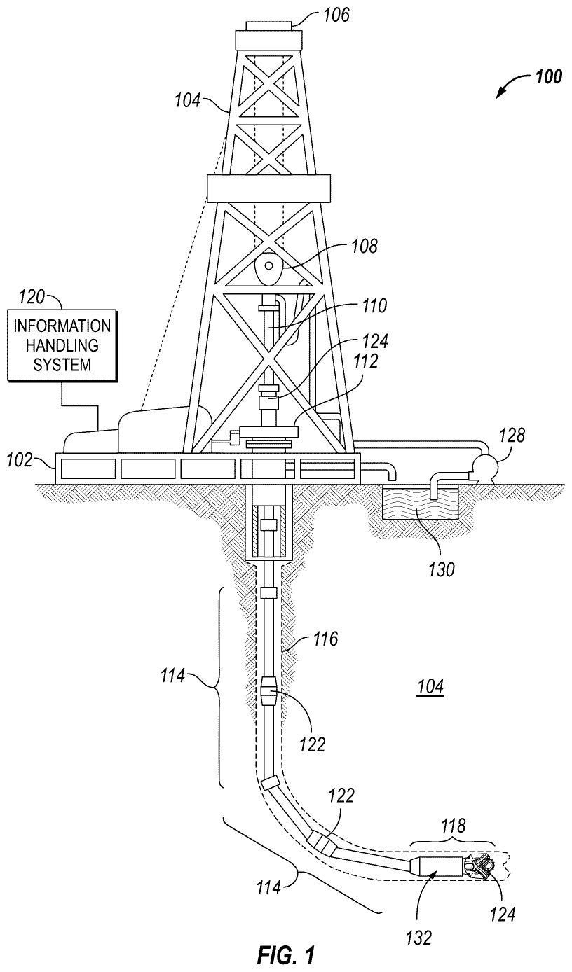

FIG. 1 is a diagram of an example drilling environment. Drilling environment 100 may include platform 102 that supports derrick 104 having a traveling block 108 for raising and lowering top drive 110 and drillstring 114. Top drive 110 supports and rotates drillstring 114 as it is lowered through wellhead 112. In turn, drill bit 124, located at the end of drillstring 114, may create borehole 116. Borehole 116 may be formed through the Earth surface into a subterranean formation 126 in the Earth crust. Bottom-hole assembly 118 may include a pulsed neutron logging tool 132 (e.g., having a scintillator that is CeBr₃) for logging while drilling operations. Each of these components is described below. Pulsed neutron logging tool 132 may be a dual-purpose (dual application) gamma-ray spectroscopy logging tool in contemporaneously (e.g., on the same run) detecting (facilitating measuring) both (1) neutron-induced gamma rays from the subterranean formation 126 and (2) natural gamma rays from the subterranean formation 126. In implementations for logging while drilling, such dual application may reduce complexity of bottom-hole assembly 118 and save rig time in facilitating spectroscopic measurements of both neutron-induced gamma rays and natural gamma rays in a single run (in the same run) into borehole 116.

Platform 102 is a structure which may be used to support one or more other components of drilling environment 100 (e.g., derrick 104). Platform 102 may be designed and constructed from suitable materials (e.g., concrete) which are able to withstand the forces applied by other components (e.g., the weight and counterforces experienced by derrick 104). In any embodiment, platform 102 may be constructed to provide a uniform surface for drilling operations in drilling environment 100.

Derrick 104 is a structure which may support, contain, and/or otherwise facilitate the operation of one or more pieces of the drilling equipment. In any embodiment, derrick 104 may provide support for crown block 106, traveling block 108, and/or any part connected to (and including) drillstring 114. Derrick 104 may be constructed from any suitable materials (e.g., steel) to provide the strength necessary to support those components.

Crown block 106 is one or more simple machine(s) which may be rigidly affixed to derrick 104 and include a set of pulleys (e.g., a “block”), threaded (e.g., “reeved”) with a drilling line (e.g., a steel cable), to provide mechanical advantage. Crown block 106 may be disposed vertically above traveling block 108, where traveling block 108 is threaded with the same drilling line.

Traveling block 108 is one or more simple machine(s) which may be movably affixed to derrick 104 and include a set of pulleys, threaded with a drilling line, to provide mechanical advantage. Traveling block 108 may be disposed vertically below crown block 106, where crown block 106 is threaded with the same drilling line. In any embodiment, traveling block 108 may be mechanically coupled to drillstring 114 (e.g., via top drive 110) and allow for drillstring 114 (and/or any component thereof) to be lifted from (and out of) borehole 116. Both crown block 106 and traveling block 108 may use a series of parallel pulleys (e.g., in a “block and tackle” arrangement) to achieve significant mechanical advantage, allowing for the drillstring to handle greater loads (compared to a configuration that uses non-parallel tension). Traveling block 108 may move vertically (e.g., up, down) within derrick 104 via the extension and retraction of the drilling line.

Top drive 110 is a machine which may be configured to rotate drillstring 114. Top drive 110 may be affixed to traveling block 108 and configured to move vertically within derrick 104 (e.g., along with traveling block 108). In any embodiment, the rotation of drillstring 114 (caused by top drive 110) may allow for drillstring 114 to carve borehole 116. Top drive 110 may use one or more motor(s) and gearing mechanism(s) to cause rotations of drillstring 114. In any embodiment, a rotatory table (not shown) and a “Kelly” drive (not shown) may be used in addition to, or instead of, top drive 110.

Wellhead 112 is a machine which may include one or more pipes, caps, and/or valves to provide pressure control for contents within borehole 116 (e.g., when fluidly connected to a well (not shown)). In any embodiment, during drilling, wellhead 112 may be equipped with a blowout preventer (not shown) to prevent the flow of higher-pressure fluids (in borehole 116) from escaping to the surface in an uncontrolled manner. Wellhead 112 may be equipped with other ports and/or sensors to monitor pressures within borehole 116 and/or otherwise facilitate drilling operations.

Drillstring 114 is a machine which may be used to carve borehole 116 and/or gather data from borehole 116 and the surrounding geology. Drillstring 114 may include one or more drillpipe(s), one or more repeater(s) 122, and bottom-hole assembly 118. Drillstring 114 may rotate (e.g., via top drive 110) to form and deepen borehole 116 (e.g., via drill bit 124) and/or via one or more motor(s) attached to drillstring 114.

Borehole 116 is a hole in the ground which may be formed by drillstring 114 (and one or more components thereof). Borehole 116 may be partially or fully lined with casing to protect the surrounding ground from the contents of borehole 116, and conversely, to protect borehole 116 from the surrounding ground.

Bottom-hole assembly 118 is a machine which may be equipped with one or more tools for creating, providing structure, and maintaining borehole 116, as well as one or more tools for measuring the surrounding environment (e.g., measurement while drilling (MWD), logging while drilling (LWD)). In any embodiment, bottom-hole assembly 118 may be disposed at (or near) the end of drillstring 114 (e.g., in the most “downhole” portion of borehole 116).

Non-limiting examples of tools that may be included in bottom-hole assembly 118 include a drill bit (e.g., drill bit 124), casing tools (e.g., a shifting tool), a plugging tool, a mud motor, a drill collar (thick-walled steel pipes that provide weight and rigidity to aid the drilling process), actuators (and pistons attached thereto), a steering system, and any measurement tool (e.g., sensors, probes, particle generators, etc.).

Further, bottom-hole assembly 118 may include a telemetry sub to maintain a communications link with the surface (e.g., with information handling system 120). Such telemetry communications may be used for (i) transferring tool measurement data from bottom-hole assembly 118 to surface receivers, and/or (ii) receiving commands (from the surface) to bottom-hole assembly 118 (e.g., for use of one or more tool(s) in bottom-hole assembly 118). In examples, telemetry communications may be at least in part between bottom-hole assembly 118 and information handling system 120.

As illustrated, the information handling system 120 may comprise any instrumentality or aggregate of instrumentalities operable to compute, estimate, classify, process, transmit, broadcast, receive, retrieve, originate, switch, store, display, manifest, detect, record, reproduce, handle, or utilize any form of information, intelligence, or data for business, scientific, control, or other purposes. For example, an information handling system 120 may be a personal computer, a network storage device, or any other suitable device and may vary in size, shape, performance, functionality, and price.

Information handling system 120 may include a processing unit (e.g., microprocessor, central processing unit, etc.) that may process drilling data from rotary steerable system (RSS) 242, discussed below, by executing software or instructions obtained from a local non-transitory computer readable media (e.g., optical disks, magnetic disks). The non-transitory computer readable media may store software or instructions of the methods described herein. Non-transitory computer readable media may include any instrumentality or aggregation of instrumentalities that may retain data and/or instructions for a period of time. Non-transitory computer readable media may include, for example, storage media such as a direct access storage device (e.g., a hard disk drive or floppy disk drive), a sequential access storage device (e.g., a tape disk drive), compact disk, CD-ROM, DVD, random access memory (RAM), read only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 120 may also include input device(s) (e.g., keyboard, mouse, touchpad, etc.) and output device(s) (e.g., monitor, printer, etc.). The input device(s) and output device(s) provide a user interface that enables an operator to interact with any device disposed or a part of bottom-hole assembly 118, discussed below, and/or software executed by a processing unit. For example, information handling system 120 may enable an operator to select analysis options, view collected log data, view analysis results, and/or perform other tasks.

Non-limiting examples of techniques for transferring tool measurement data (to the surface) include mud pulse telemetry and through-wall acoustic signaling. For through-wall acoustic signaling, one or more repeater(s) 122 may detect, amplify, and re-transmit signals from bottom-hole assembly 118 to the surface (e.g., to information handling system 120), and conversely, from the surface (e.g., from information handling system 120) to bottom-hole assembly 118.

Repeater 122 is a device which may be used to receive and send signals from one component of drilling environment 100 to another component of drilling environment 100. As a non-limiting example, repeater 122 may be used to receive a signal from a tool on bottom-hole assembly 118 and send that signal to information handling system 120. Two or more repeaters 122 may be used together, in series, such that a signal to/from bottom-hole assembly 118 may be relayed through two or more repeaters 122 before reaching its destination.

A transducer is a device that may work with repeater 122 to transfer information from the surface to bottom-hole assembly 118. A transducer may be configured to convert non-digital data (e.g., vibrations, other analog data) into a digital form suitable for information handling system 120. As a non-limiting example, the one or more transducer(s) may convert signals between mechanical and electrical forms, enabling information handling system 120 to receive the signals from a telemetry sub, on bottom-hole assembly 118, and conversely, transmit a downlink signal to the telemetry sub on bottom-hole assembly 118. In any embodiment, the transducer may be located at the surface and/or any part of drillstring 114 (e.g., as part of bottom-hole assembly 118).

Drill bit 124 is a machine which may be used to cut through, scrape, and/or crush (i.e., break apart) materials in the ground (e.g., rocks, dirt, clay, etc.). Drill bit 124 may be disposed at the frontmost point of drillstring 114 and bottom-hole assembly 118. In any embodiment, drill bit 124 may include one or more cutting edges (e.g., hardened metal points, surfaces, blades, protrusions, etc.) to form a geometry which aids in breaking ground materials loose and further crushing that material into smaller sizes. In any embodiment, drill bit 124 may be rotated and forced into (i.e., pushed against) the ground material to cause the cutting, scraping, and crushing action. The rotations of drill bit 124 may be caused by top drive 110 and/or one or more motor(s) located on drillstring 114 (e.g., on bottom-hole assembly 118).

Pump 128 is a machine that may be used to circulate drilling fluid 130 from a reservoir, through a feed pipe, to derrick 104, to the interior of drillstring 114, out through drill bit 124 (through orifices, not shown), back upward through borehole 116 (around drillstring 114), and back into the reservoir. In any embodiment, any appropriate pump 128 may be used (e.g., centrifugal, gear, etc.) which is powered by any suitable means (e.g., electricity, combustible fuel, etc.).

Drilling fluid 130 is a liquid which may be pumped through drillstring 114 and borehole 116 to collect drill cuttings, debris, and/or other ground material from the end of borehole 116 (e.g., the volume most recently hollowed by drill bit 124). Further, drilling fluid 130 may provide conductive cooling to drill bit 124 (and/or bottom-hole assembly 118). In any embodiment, drilling fluid 130 may be circulated via pump 128 and filtered to remove unwanted debris.

During drilling operations, bottom-hole assembly may comprise, at least in part, a pulsed neutron logging tool 132. This may allow for logging while drilling operations to be performed. Measurements taken by pulsed neutron logging tool 132 may be gathered and/or processed by information handling system 120. For example, measurements taken by pulsed neutron logging tool 132 may be sent to information handling system 120 where they may be stored on memory and then processed. The processing may be performed real-time during data acquisition or after recovery of pulsed neutron logging tool 132. Processing may alternatively occur downhole on an information handling system disposed on and/or near pulsed neutron logging tool 132 or may occur both downhole and at surface. Information handling system 120 may process the signals, and the information contained therein may be displayed for an operator to observe and stored for future processing and reference. Information handling system 120 may also contain an apparatus for supplying control signals and power to pulsed neutron logging tool 132. Although illustrated as disposed on bottom-hole assembly 118 in a drilling operation, pulsed neutron logging tool 132 may also be disposed in borehole 116 in a wireline operation. Moreover, as mentioned, pulsed neutron logging tool 132 may have a scintillator detector having a scintillator (scintillation crystal) that is or includes CeBr₃.

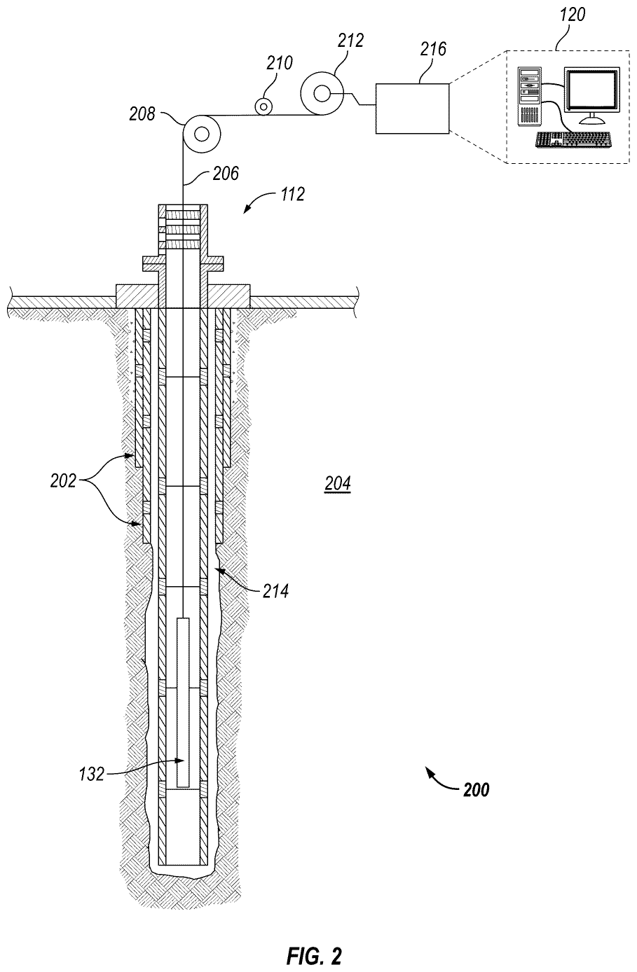

FIG. 2 illustrates a wireline operation 200, as disclosed herein, utilizing a pulsed neutron logging tool 132. Pulsed neutron logging tool 132 may have a scintillator detector in which the scintillator may be or include CeBr₃. FIG. 2 illustrates a cross-section of borehole 116 with a pulsed neutron logging tool 132 traveling through casing string 202. Borehole 116 may traverse through subterranean formation 204 as a vertical well and/or a horizontal well. Pulsed neutron logging tool 132 may be suspended by a conveyance 206, which communicates power from a logging facility 216 (logging center) to pulsed neutron logging tool 132 and communicates telemetry from pulsed neutron logging tool 132 to information handling system 120. In examples, pulsed neutron logging tool 132 may be operatively coupled to a conveyance 206 (e.g., wireline, slickline, coiled tubing, pipe, downhole tractor, and/or the like) which may provide mechanical suspension, as well as electrical connectivity, for pulsed neutron logging tool 132. Conveyance 206 and pulsed neutron logging tool 132 may extend within casing string 202 to a depth within borehole 116. Conveyance 206, which may include one or more electrical conductors, may exit wellhead 112, may pass around pulley 208, may engage odometer 210, and may be reeled onto winch 212, which may be employed to raise and lower the tool assembly in borehole 116. Wellhead 112 may allow for entry into borehole 116 and placement of pulsed neutron logging tool 132 into pipe string 214. The position of pulsed neutron logging tool 132 may be monitored in a number of ways, including an inertial tracker in pulsed neutron logging tool 132 and a paid-out conveyance length monitor in logging facility 216.

Multiple such measurements may be desirable to enable the system to compensate for varying cable tension and cable stretch due to other factors. Information handling system 120 in logging facility 216 collects telemetry and position measurements and provides position-dependent logs of measurements from pulsed neutron logging tool 132 and values that may be derived therefrom.

Pulsed neutron logging tool 132 generally includes multiple instruments for measuring a variety of downhole parameters. Wheels, bow springs, fins, pads, or other centralizing mechanisms may be employed to keep pulsed neutron logging tool 132 near the borehole axis during measurement operations. During measurement operations, generally, measurements may be performed as pulsed neutron logging tool 132 is drawn up hole at a constant rate. The parameters and instruments may vary depending on the needs of the measurement operation.

Measurements taken by pulsed neutron logging tool 132 may be gathered and/or processed by information handling system 120. For example, signals recorded by pulsed neutron logging tool 132 may be sent to information handling system 120 where they may be stored on memory and then processed. The processing may be performed real-time during data acquisition or after recovery of pulsed neutron logging tool 132. Processing may alternatively occur downhole on an information handling system disposed on pulsed neutron logging tool 132 or may occur both downhole and at surface. In some examples, signals recorded by pulsed neutron logging tool 132 may be conducted to information handling system 120 by way of conveyance 206. Information handling system 120 may process the signals, and the information contained therein may be displayed for an operator to observe and stored for future processing and reference. Information handling system 120 may also contain an apparatus for supplying control signals and power to pulsed neutron logging tool 132.

In wireline operations 200, a digital telemetry system may be employed, wherein an electrical circuit may be used to both supply power to pulsed neutron logging tool 132 and to transfer data between information handling system 120 and pulsed neutron logging tool 132. A DC voltage may be provided to pulsed neutron logging tool 132 by a power supply located above ground level, and data may be coupled to the DC power conductor by a baseband current pulse system. Alternatively, pulsed neutron logging tool 132 may be powered by batteries located within the downhole tool assembly, and/or the data provided by pulsed neutron logging tool 132 may be stored within the downhole tool assembly, rather than transmitted to the surface during logging.

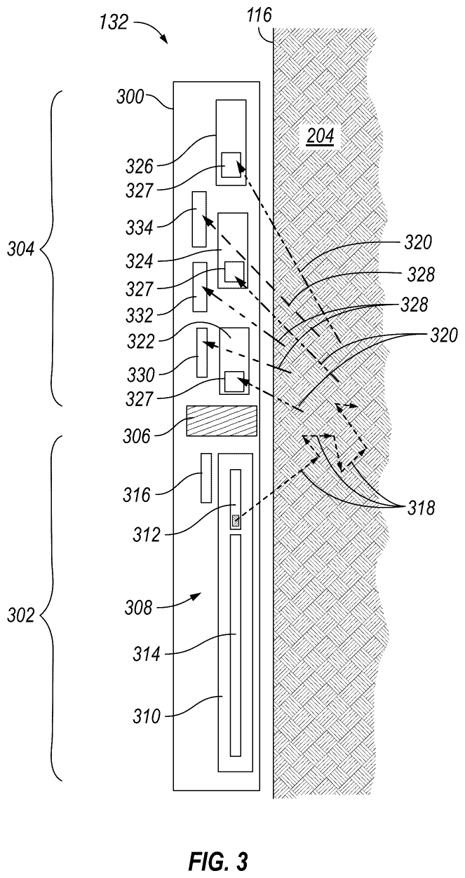

FIG. 3 illustrates pulsed neutron logging tool 132 disposed in borehole 116. It should be noted, as discussed above, that pulsed neutron logging tool 132 may be disposed on a bottom-hole assembly 118 (e.g., referring to FIG. 1) in a logging while drilling operation or utilized in a wireline operation (e.g., referring to FIG. 2). Additionally, the orientation of pulsed neutron logging tool 132, whether the pulsed neutron generator is disposed above or below the detectors, is inconsequential.

With continued reference to FIG. 3, pulsed neutron logging tool 132 may comprise an outer housing 300 which may be formed from a heavy metal such as steel, Inconel, etc. Housing 300 may protect the internal devices of pulsed neutron logging tool 132 from the downhole environment that pulsed neutron logging tool 132 may experience in borehole 116. As illustrated, pulsed neutron logging tool 132 may be divided into a generator area 302 (generation area) and a detection area 304 (detector area) that are separated by shielding 306. From generator area 302, neutrons may be generated and broadcast into formation 204 (referring to FIG. 2). Detection area 304 may be operated and function to detect gamma rays that may originate from formation 204 naturally or induced by the broadcast of neutrons into formation 204.

Generator area 302 may comprise a pulsed neutron generator 308 that may be packaged within silicon hexafluoride (SF₆) housing 310 that has or is configured for SF₆ gas therein as an insulating gas for a high voltage environment. SF₆ housing 310 (an inner housing within outer housing 300) may be comprised of a heavy metal like stainless steel, etc. As noted above, within SF₆ housing 310 may be a pulsed neutron generator 308 that may further comprise a neutron tube 312, which generates neutrons for broadcasting, and a high voltage (HV) ladder power supply 314 that may be utilized to power neutron tube 312. In other examples, pulsed neutron generator 308 may be replaced with a continuous neutron source such as Americium-Beryllium (Am-Be) chemical source or other types of chemical sources. Moreover, while housing 310 is labeled as an SF₆ housing, the housing 310 may house (contain) another insulating gas (dielectric gas) in lieu of SF₆. Further, liquid or solid media (instead of an insulating gas) may be employed as an insulator of the high voltage. Outside of SF₆ housing 310 may be a fast neutron monitor 316, that may be utilized to monitor the broadcasting of neutrons 318 from generator area 302 into formation 204. For example, during operations, pulsed neutron logging tool 132 may generate pulses of high energy neutrons that radiate from pulsed neutron generator 308 into the surrounding environment including borehole 116 and formation 204. The highly energetic neutrons 318 entering the surrounding environment interact with atomic nuclei, inducing gamma ray radiation. Induced inelastic and capture gamma rays 320 and thermal neutrons 328 may be sensed and recorded by detection area 304. The inelastic and capture gamma rays 320 sensed and recorded include inelastic gamma rays. The inelastic and capture gamma rays 320 sensed and recorded include capture gamma rays different than the inelastic gamma rays. The scattered neutrons and gamma ray spectrum may be measured to determine properties of borehole 116 and formation 204. Through processing, the measurements may be utilized to identify oil and gas in formation 204 as well as determining the flow in production wells. As illustrated, neutrons 318 may be broadcasted into formation 204, wherein neutrons 318 may interact with material within formation 204 to create inelastic and capture gamma rays 320, discussed in greater detail below. Inelastic and capture gamma rays 320 may be detected, sensed, and/or measured by devices within detection area 304 of pulsed neutron logging tool 132. Inelastic gamma rays are generally induced by fast neutrons while capture gamma rays are induced by thermal neutrons capturing. Natural gamma rays naturally occur from the formation 204 and may be measured via the pulsed neutron logging tool 132 with the pulsed neutron generator 308 turned OFF (not generating or pulsing neutrons), or with the pulsed neutron generator 308 in a prolonged OFF state in a given pulsing sequence. The technique may include performing in a borehole, via the pulsed neutron logging tool, spectroscopy measurements of natural gamma rays, pulsed neutron induced inelastic gamma rays, and pulsed neutron induced capture gamma rays.

Detection area 304 may comprise a number of devices that may be utilized to detect, sense, and/or measure inelastic and/or capture gamma rays 320. As illustrated, a number of gamma ray scintillator detectors may be utilized, which implement a scintillation crystal (e.g., CeBr₃) coupled to a photomultiplier tube. The scintillation crystal may be labeled as a scintillator 327. In examples, gamma ray scintillator detectors may be identified as a near gamma ray scintillator detector 322, a far gamma ray scintillator detector 324, and a long gamma ray scintillator detector 326. Identification of each scintillator detector as near, far, and long is due to the distance from neutron generator 308. For example, the closest scintillator detector to neutron generator 308 is “near,” the second closest is “far”, and the third closest is “long.” This nomenclature may also be utilized for thermal neutron detectors that may also be disposed within detection area 304 and may operate and function to detect thermal neutrons 328 that may originate from formation 204 during the interaction of neutrons 318 with material within formation 204. For example, neutron detectors may operate and function to count thermal (around about 0.025 eV) and/or epithermal (between about 0.1 eV and 100 eV) neutrons. Suitable neutron detectors include Helium-3 (He-3) filled proportional counters, though other neutron counters may also be used. Thus, within detection area 304 may be a near thermal neutron detector 330, a far thermal neutron detector 332, and a long thermal neutron detector 334. As noted above, detection area 304 may be separated from generator area 302 by shielding 306.

Shielding 306 may be a structure formed of a heavy metal like tungsten. This material may operate and function to prevent neutrons 318 that may be generated from pulsed neutron generator 308 from being detected by the detectors in detection area 304. Without shielding 306, neutrons 318 generated from pulsed neutron generator 308 may saturate all detectors within detection area 304 and prevent the detection and measurement of gamma rays and neutrons from formation 204.

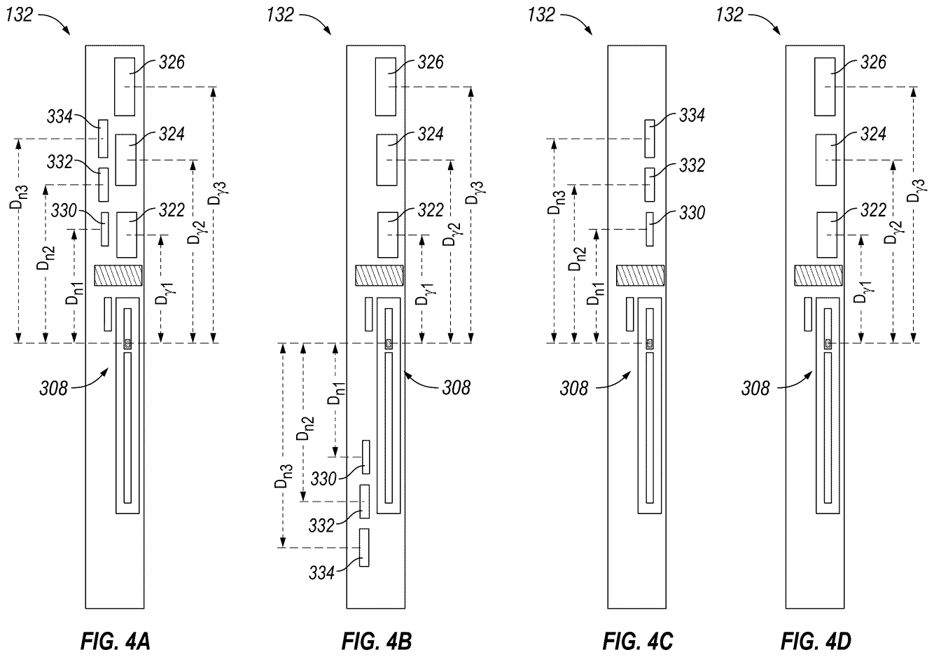

FIGS. 4A-4C illustrate different embodiments of pulsed neutron logging tool 132. FIG. 4A illustrates an embodiment shown in FIG. 3. In this embodiment, the distance from pulsed neutron generator 308 to near thermal neutron detector 330 is Dₙ₁, to far thermal neutron detector 332 is Dₙ₂, and to long thermal neutron detector 334 is Dₙ₃. Further, the distance from pulsed neutron generator 308 to a near gamma ray scintillator detector 322 is D_{γ1}, a far gamma ray scintillator detector 324 is D_{γ2}, and a long gamma ray scintillator detector 326 is D_{γ3}. FIG. 4B illustrates another embodiment in which the distances Dₙ₁, Dₙ₂, Dₙ₃ from pulsed neutron generator 308 to each thermal neutron detector 330, 332, 334 have changed as each thermal neutron detector is now disposed within generator area 302. FIG. 4C illustrates an embodiment where gamma ray scintillator detectors 332, 324, and 326 (with distances D_{γ1}, D_{γ2}, D_{γ3}) are utilized, but thermal neutron detectors 330, 332, 334 are not utilized.

Multiple detectors of pulsed neutron logging tool 132, may enable pulsed neutron logging tool 132 to measure properties of formation 204 and borehole 116 (e.g., referring to FIG. 3) using any of the existing multiple-spacing techniques. In addition, the presence of gamma ray detectors (e.g., 320, 322, 324) which have proper distances from pulsed neutron generator 308, may enable the measurement of elemental gamma ray spectroscopy.

As discussed above, during measurement operations, neutrons 318 (e.g., referring to FIG. 3) emitted from neutron source or pulsed neutron generator 308 undergo neutron scattering and/or nuclear absorption when interacting with matter. Scattering may either be elastic (n, n) or inelastic (n, n′). In an elastic interaction a fraction of the neutrons kinetic energy is transferred to the nucleus. An inelastic interaction is similar, except the nucleus undergoes an internal rearrangement. Additionally, neutrons may also undergo an absorption interaction. During interactions, the elastic cross section is nearly constant, whereas the inelastic scattering cross section and absorption cross sections are proportional to the reciprocal of the neutron speed. For example, inelastic scatterings appear for fast neutrons in the MeV energy range, whereas absorptions happen when neutrons slowed down in the eV energy range.

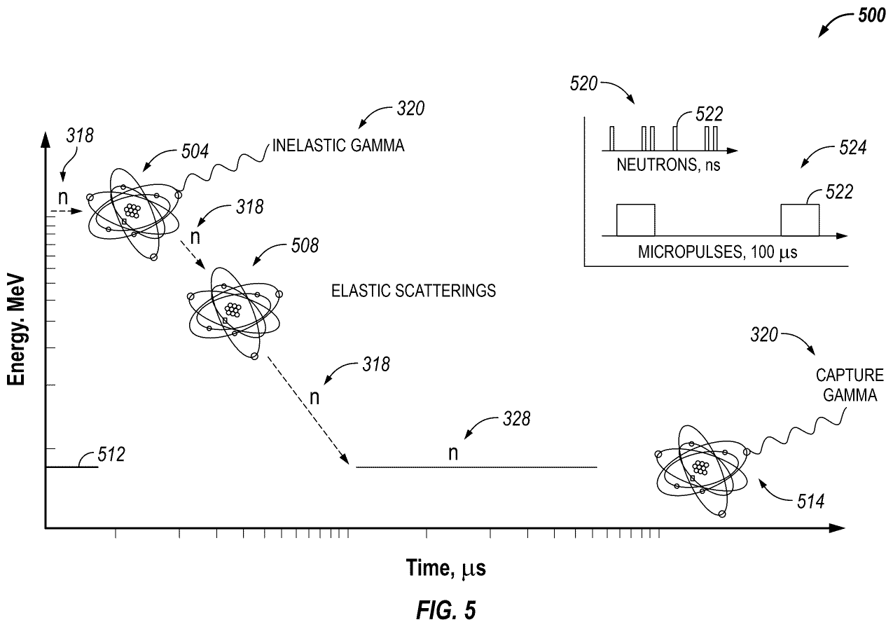

FIG. 5 illustrates a graph 500 that depicts different scattering by a neutron 318. As illustrated, neutron 318 may be traveling at a fast speed with high kinetic energy and interacts with nuclei 504, releasing inelastic gamma ray 320 and lowering the energy state of neutron 318. After the interaction, neutron 318 contains too much energy to be absorbed, thus continuing its path until it interacts with nuclei 508 releasing inelastic gamma ray 320 and again lowering its energy state again. After the interactions, neutron 318 has kinetic energy close to target energy 512, and becomes a thermal neutron 328. Thus, when neutron 328 at target energy 512 interacts with nuclei 514 it will be captured. This interaction results in nuclei 514 being rearranged to contain previously traveling neutron 328 and an emitted capture gamma ray 320. Sensing these events with pulsed neutron logging tool 132 using detection area 304 may allow for the identification of oil, gas, and/or water in borehole 116 and formation 204 (e.g., referring to FIG. 3).

With continued reference to FIG. 5, the neutron to gamma ray timing information may be utilized during measurement operations in which a pulsing neutron generator is utilized. In a sub-μs time domain, inelastic gamma rays dominate, whereas in a 10-1000 μs time range, there are only capture gamma rays. Insert 520 on FIG. 5 illustrates an example of neutrons in a neutron pulse 522 and insert 524 shows the relationship of two adjacent neutron pulses 522 with a given pulse width and timing interval. Pulsing schemes allow isolation of inelastic and capture gamma rays 320, and then allow elemental determinations of different nuclei in the bore hole, formation, or fluids.

During measurement operations, pulsed neutron logging tool 132 may take any number of measurements of inelastic and capture gamma rays 320 and/or thermal neutrons 328 (e.g., referring to FIG. 3). The pulsed neutron logging tool 132 may also take measurements of natural gamma rays from the formation 204 with the pulsed neutron generator 308 in a prolonged OFF state (not generating neutrons) with a given pulsing sequence. These measurements may be further processed by additional methods and systems that may utilize information handling system 120.

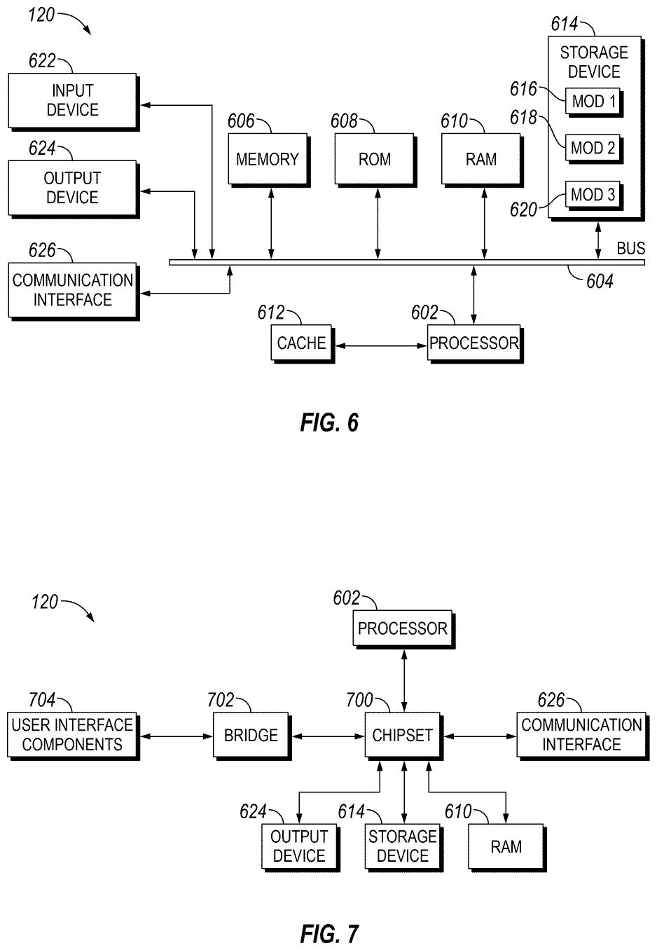

FIG. 6 further illustrates an example information handling system 120 which may be employed to perform various steps, methods, and techniques disclosed herein. Persons of ordinary skill in the art will readily appreciate that other system examples are possible. As illustrated, information handling system 120 includes a processing unit (CPU or processor) 602 and a system bus 604 that couples various system components including system memory 606 such as ROM 608 and RAM 610 to processor 602. Processors disclosed herein may all be forms of this processor 602. Information handling system 120 may include a cache 612 of high-speed memory connected directly with, in close proximity to, or integrated as part of processor 602. Information handling system 120 copies data from memory 606 and/or storage device 614 to cache 612 for quick access by processor 602. In this way, cache 612 provides a performance boost that avoids processor 602 delays while waiting for data. These and other modules may control or be configured to control processor 602 to perform various operations or actions. Other system memory 606 may be available for use as well. Memory 606 may include multiple different types of memory with different performance characteristics. It may be appreciated that the disclosure may operate on information handling system 120 with more than one processor 602 or on a group or cluster of computing devices networked together to provide greater processing capability. Processor 602 may include any general-purpose processor and a hardware module or software module, such as first module 616, second module 618, and third module 620 stored in storage device 614, configured to control processor 602 as well as a special-purpose processor where software instructions are incorporated into processor 602. Processor 602 may be a self-contained computing system, containing multiple cores or processors, a bus, memory controller, cache, etc. A multi-core processor may be symmetric or asymmetric. Processor 602 may include multiple processors, such as a system having multiple, physically separate processors in different sockets, or a system having multiple processor cores on a single physical chip. Similarly, processor 602 may include multiple distributed processors located in multiple separate computing devices but working together such as via a communications network. Multiple processors or processor cores may share resources such as memory 606 or cache 612 or may operate using independent resources. Processor 602 may include one or more state machines, an application specific integrated circuit (ASIC), or a programmable gate array (PGA) including a field PGA (FPGA).

Each individual component discussed above may be coupled to system bus 604, which may connect each and every individual component to each other. System bus 604 may be any of several types of bus structures including a memory bus or memory controller, a peripheral bus, and a local bus using any of a variety of bus architectures. A basic input/output (BIOS) stored in ROM 608 or the like, may provide the basic routine that helps to transfer information between elements within information handling system 120, such as during start-up. Information handling system 120 further includes storage devices 614 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 614 may include software modules 616, 618, and 620 for controlling processor 602. Information handling system 120 may include other hardware or software modules. Storage device 614 is connected to the system bus 604 by a drive interface. The drives and the associated computer-readable storage devices provide nonvolatile storage of computer-readable instructions, data structures, program modules and other data for information handling system 120. In one aspect, a hardware module that performs a particular function includes the software component stored in a tangible computer-readable storage device in connection with hardware components, such as processor 602, system bus 604, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 120 is a small, handheld computing device, a desktop computer, or a computer server. When processor 602 executes instructions to perform “operations”, processor 602 may perform the operations directly and/or facilitate, direct, or cooperate with another device or component to perform the operations.

As illustrated, information handling system 120 employs storage device 614, which may be a hard disk or other types of computer-readable storage devices which may store data that are accessible by a computer, such as magnetic cassettes, flash memory cards, digital versatile disks (DVDs), cartridges, random access memories (RAMs) 610, read only memory (ROM) 608, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 120, an input device 622 represents any number of input mechanisms, such as a microphone for speech, a touch-sensitive screen for gesture or graphical input, keyboard, mouse, motion input, speech and so forth. Additionally, input device 622 may receive one or more measurements from bottom-hole assembly 118 (e.g., referring to FIG. 1), discussed above. An output device 624 may also be one or more of a number of output mechanisms known to those of skill in the art. In some instances, multimodal systems enable a user to provide multiple types of input to communicate with information handling system 120. Communications interface 626 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 602, that is purpose-built to operate as an equivalent to software executing on a general-purpose processor. For example, the functions of one or more processors presented in FIG. 6 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 608 for storing software performing the operations described below, and random-access memory (RAM) 610 for storing results. Very large-scale integration (VLSI) hardware embodiments, as well as custom VLSI circuitry in combination with a general-purpose DSP circuit, may also be provided.

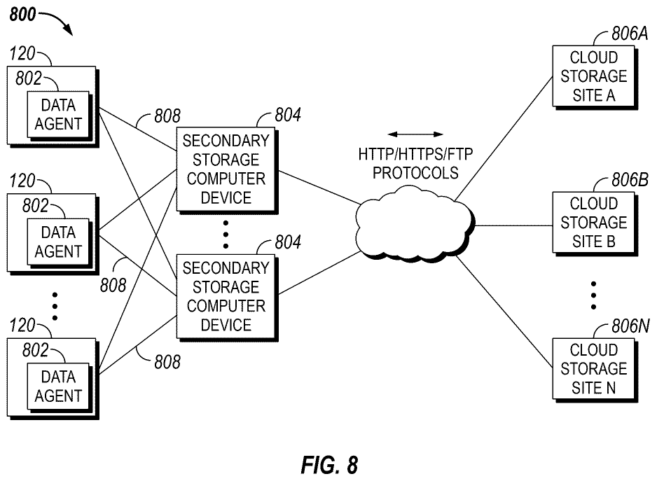

FIG. 7 illustrates an example information handling system 120 having a chipset architecture that may be used in executing the described method and generating and displaying a graphical user interface (GUI). Information handling system 120 is an example of computer hardware, software, and firmware that may be used to implement the disclosed technology. Information handling system 120 may include a processor 602, representative of any number of physically and/or logically distinct resources capable of executing software, firmware, and hardware configured to perform identified computations. Processor 602 may communicate with a chipset 700 that may control input to and output from processor 602. In this example, chipset 700 outputs information to output device 624, such as a display, and may read and write information to storage device 614, which may include, for example, magnetic media, and solid-state media. Chipset 700 may also read data from and write data to RAM 610. A bridge 702 for interfacing with a variety of user interface components 704 may be provided for interfacing with chipset 700. Such user interface components 704 may include a keyboard, a microphone, touch detection and processing circuitry, a pointing device, such as a mouse, and so on. In general, inputs to information handling system 120 may come from any of a variety of sources, machine generated and/or human generated.

Chipset 700 may also interface with one or more communication interfaces 626 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 602 analyzing data stored in storage device 614 or RAM 610. Further, information handling system 120 receives inputs from a user via user interface components 704 and executes appropriate functions, such as browsing functions by interpreting these inputs using processor 602.

In examples, information handling system 120 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

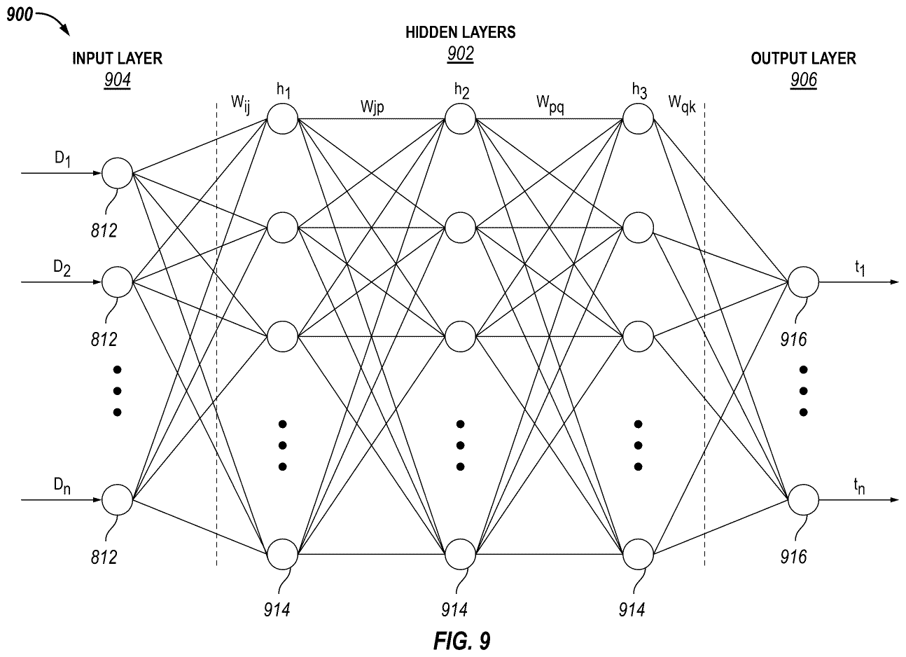

FIG. 8 illustrates an example of one arrangement of resources in a computing network 800 that may employ the processes and techniques described herein, although many others are of course possible. As noted above, an information handling system 120, as part of their function, may utilize data, which includes files, directories, metadata (e.g., access control list (ACLS) creation/edit dates associated with the data, etc.), and other data objects. The data on the information handling system 120 is typically a primary copy (e.g., a production copy). During a copy, backup, archive or other storage operation, information handling system 120 may send a copy of some data objects (or some components thereof) to a secondary storage computing device 804 by utilizing one or more data agents 802.

A data agent 802 may be a desktop application, website application, or any software-based application that is run on information handling system 120. As illustrated, information handling system 120 may be disposed at any rig site (e.g., referring to FIG. 1), off site location, or repair and manufacturing center. The data agent may communicate with a secondary storage computing device 804 using communication protocol 808 in a wired or wireless system. Communication protocol 808 may function and operate as an input to a website application. In the website application, field data related to pre- and post-operations, generated DTCs, notes, and the like may be uploaded. Additionally, information handling system 120 may utilize communication protocol 808 to access processed measurements, operations with similar DTCs, troubleshooting findings, historical run data, and/or the like. This information is accessed from secondary storage computing device 804 by data agent 802, which is loaded on information handling system 120.

Secondary storage computing device 804 may operate and function to create secondary copies of primary data objects (or some components thereof) in various cloud storage sites 806A-N. Additionally, secondary storage computing device 804 may run determinative algorithms on data uploaded from one or more information handling systems 120, discussed further below. Communications between the secondary storage computing devices 804 and cloud storage sites 806A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 806A-N, the secondary storage computing device 804 may also perform local content indexing and/or local object-level, sub-object-level or block-level deduplication when performing storage operations involving various cloud storage sites 806A-N. Cloud storage sites 806A-N may further record and maintain, EM logs, map DTC codes, store repair and maintenance data, store operational data, and/or provide outputs from determinative algorithms that are located in cloud storage sites 806A-N. In a non-limiting example, this type of network may be utilized as a platform to store, backup, analyze, import, preform extract, transform and load (“ETL”) processes, mathematically process, apply machine learning models, and augment EM measurement data sets.

A machine learning model may be an empirically derived model which may result from a machine learning algorithm identifying one or more underlying relationships within a dataset. In comparison to a physics-based model, such as Maxwell's Equations, which are derived from first principles and define the mathematical relationship of a system, a pure machine learning model may not be derived from first principles. Once a machine learning model is developed, it may be queried in order to predict one or more outcomes for a given set of inputs. The type of input data used to query the model to create the prediction may correlate both in category and type to the dataset from which the model was developed.

The structure of, and the data contained within a dataset provided to a machine learning algorithm may vary depending on the intended function of the resulting machine learning model. The rows of data, or data points, within a dataset may contain one or more independent values. Additionally, datasets may contain corresponding dependent values. The independent values of a dataset may be referred to as “features,” and a collection of features may be referred to as a “feature space.” If dependent values are available in a dataset, they may be referred to as outcomes or “target values.” Although dependent values may be a component of a dataset for certain algorithms, not all algorithms utilize a dataset with dependent values. Furthermore, both the independent and dependent values of the dataset may comprise either numerical or categorical values.

While it may be true that machine learning model development is more successful with a larger dataset, it may also be the case that the whole dataset isn't used to train the model. A test dataset may be a portion of the original dataset which is not presented to the algorithm for model training purposes. Instead, the test dataset may be used for what may be known as “model validation,” which may be a mathematical evaluation of how successfully a machine learning algorithm has learned and incorporated the underlying relationships within the original dataset into a machine learning model. This may include evaluating model performance according to whether the model is over-fit or under-fit. As it may be assumed that all datasets contain some level of error, it may be important to evaluate and optimize the model performance and associated model fit by a model validation. In general, the variability in model fit (e.g.: whether a model is over-fit or under-fit) may be described by the “bias-variance trade-off.” As an example, a model with high bias may be an under-fit model, where the developed model is over-simplified, and has either not fully learned the relationships within the dataset or has over-generalized the underlying relationships. A model with high variance may be an over-fit model which has overlearned about non-generalizable relationships within training dataset which may not be present in the test dataset. In a non-limiting example, these non-generalizable relationships may be driven by factors such as intrinsic error, data heterogeneity, and the presence of outliers within the dataset. The selected ratio of training data to test data may vary based on multiple factors, including, in a non-limiting example, the homogeneity of the dataset, the size of the dataset, the type of algorithm used, and the objective of the model. The ratio of training data to test data may also be determined by the validation method used, wherein some non-limiting examples of validation methods include k-fold cross-validation, stratified k-fold cross-validation, bootstrapping, leave-one-out cross-validation, resubstituting, random subsampling, and percentage hold-out.

In addition to the parameters that exist within the dataset, such as the independent and dependent variables, machine learning algorithms may also utilize parameters referred to as “hyperparameters.” Each algorithm may have an intrinsic set of hyperparameters which guide what and how an algorithm learns about the training dataset by providing limitations or operational boundaries to the underlying mathematical workflows on which the algorithm functions. Furthermore, hyperparameters may be classified as either model hyperparameters or algorithm parameters.

Model hyperparameters may guide the level of nuance with which an algorithm learns about a training dataset, and as such model hyperparameters may also impact the performance or accuracy of the model that is ultimately generated. Modifying or tuning the model hyperparameters of an algorithm may result in the generation of substantially different models for a given training dataset. In some cases, the model hyperparameters selected for the algorithm may result in the development of an over-fit or under-fit model. As such, the level to which an algorithm may learn the underlying relationships within a dataset, including the intrinsic error, may be controlled to an extent by tuning the model hyperparameters.

Model hyperparameter selection may be optimized by identifying a set of hyperparameters which minimize a predefined loss function. An example of a loss function for a supervised regression algorithm may include the model error, wherein the optimal set of hyperparameters correlates to a model which produces the lowest difference between the predictions developed by the produced model and the dependent values in the dataset. In addition to model hyperparameters, algorithm hyperparameters may also control the learning process of an algorithm, however algorithm hyperparameters may not influence the model performance. Algorithm hyperparameters may be used to control the speed and quality of the machine learning process. As such, algorithm hyperparameters may affect the computational intensity associated with developing a model from a specific dataset.

Machine learning algorithms, which may be capable of capturing the underlying relationships within a dataset, may be broken into different categories. One such category may include whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset includes both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may include Neural Networks, K-Nearest Neighbors, Naïve Bayes, Decision Trees, Classification Trees, Regression Trees, Random Forests, Linear Regression, Support Vector Machines (SVM), Gradient Boosting Regression, and Perception Back-Propagation.

The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not include a dependent variable as the intended function of this type of algorithm is to identify one or more groupings or clusters within a dataset. In a non-limiting example, algorithms which may be utilized for unsupervised machine learning may include K-means clustering, K-means classification, Fuzzy C-Means, Gaussian Mixture, Hidden Markov Model, Neural Networks, and Hierarchical algorithms.

In examples to determine a relationship using machine learning, a neural network (NN) 900, as illustrated in FIG. 9, may be utilized to identify the quality of geologic hydrogen reservoir, using the methods described below. FIG. 9 illustrates neural network (NN) 900. NN 900 may operate utilizing one or more information handling systems 120 (e.g., referring to FIG. 1) on computing network 800. Although a NN is illustrated, multiple models may be used with input output structures. These models may include flexible empirical models such as NN, gaussian processing methods, kriging methods, evolutionary methods such as genetic algorithms, classification methods, clustering methods empirical methods, or physics-based methods such as equations of state, thermodynamic models, geological, geochemistry, or chemistry models, or kinetic models or any combinations therein including recursive combinations of similar or dissimilar models and iterative model combinations. A NN 900 is an artificial neural network with one or more hidden layers 902 between input layer 904 and output layer 906. In examples, NN 900 may be software on a single information handling system 120. In other examples, NN 900 may software running on multiple information handling systems 120 connected wirelessly and/or by a hard-wired connection in a network of multiple information handling systems 120. Herein, NN 900 may be applied in a wide array of implementations.

During operations, inputs 908 data are given to neurons 912 in input layer 904. Neurons 912, 914, and 916 are defined as individual or multiple information handling systems 120 connected in a computing network 800. The output from neurons 912 may be transferred to one or more neurons 914 within one or more hidden layers 902. Hidden layers 902 includes one or more neurons 914 connected in a network that further process information from neurons 912. The number of hidden layers 902 and neurons 912 in hidden layer 902 may be determined by personnel that designs NN 900. Hidden layers 902 is defined as a set of information handling system 120 assigned to specific processing. Hidden layers 902 spread computation to multiple neurons 912, which may allow for faster computing, processing, training, and learning by NN 900. Output from NN 900 may be computed by neurons 916. An information handling system 120 (e.g., referring to FIG. 1) being utilized in a computing network 800, NN 900, or alone may control measurement operations downhole with pulsed neutron logging tool 132 (e.g., referring to FIGS. 1&2). For example, as described above, neutrons 318 (e.g., referring to FIG. 3) may interact with elements in formation 126, 204, (e.g., referring to FIGS. 1&2) which then produce characteristic gamma rays 320 (e.g., referring to FIG. 3). One or more information handling systems 120 within a computing network, described above, may produce three measurement outputs. These outputs may be utilized for geologic hydrogen formation evaluation and monitoring.

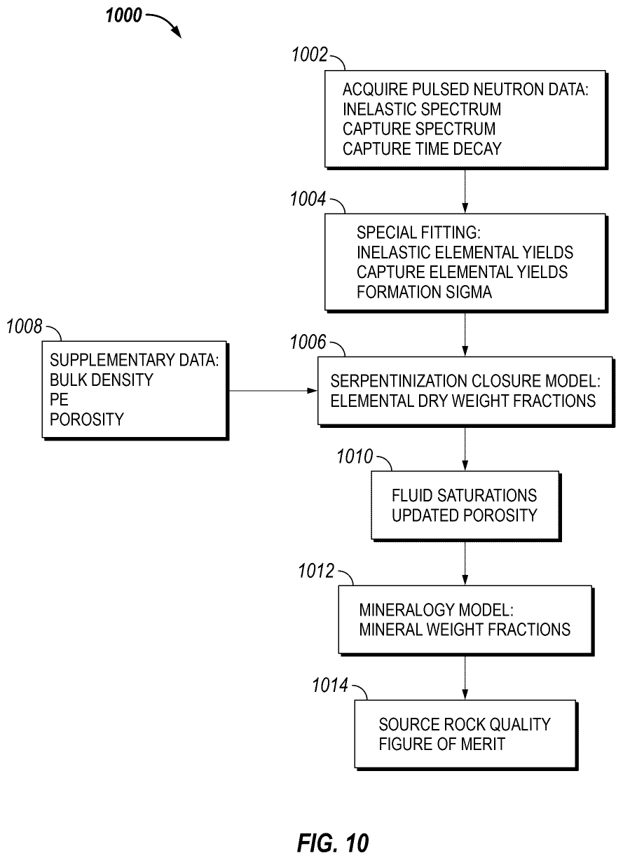

FIG. 10 illustrates workflow 1000, which may be utilized for geologic hydrogen formation evaluation and monitoring. It should be noted that workflow 1000 may be performed at least in part on information handling system 120 and/or the networks, systems, and methods described above. Workflow 1000 may begin with block 1002. In block 1002, three measurement outputs that may be formed from measurements described above, using information handling system 120, are an inelastic spectrum, a capture spectrum, and a time decay curve. In block 1004, the measurement outputs may be graphed. For example, the two spectra may be decomposed into elemental constituents, giving relative elemental yields. To illustrate, an observed spectra may be comprised of the spectra from multiple elements. Thus, an observed spectra may be decomposed into those constituent elements. As such, there may be inelastic elemental yield and capture elemental yield. The time decay curve may be fit to determine the formation sigma (total capture cross-section). In examples, be inelastic elemental yield, capture elemental yield, and formation sigma form block 1004 may further be modeled.

In block 1006, serpentinization closure model or a “closure model” may be employed, at least in part on information handling system 120, to convert the inelastic elemental yield and capture elemental yield to capture dry weight fraction and inelastic dry weight fraction. A closure model allocates the elements to a set of minerals or chemical compounds that may be present. Formations 126, 204 associated with geologic hydrogen comprise the same elements used in sedimentary analysis. Thus, existing spectral methods may be leveraged. However, this is not the case for the associated minerals, such that a new closure model is needed. Once the elemental dry weight fractions and mineral weight (or volume) fractions may be determined, a reservoir capacity figure of merit may be computed to assess the quality of the source rock, to be discussed below. Periodic logging and analysis during stimulation and/or production may be used to assess changes in reservoir capacity and/or source rock quality.

For example, the proposed closure and mineralogy models may, at least in part, cover the minerals associated with the serpentinization of olivine which relate to the natural or stimulated production of hydrogen:

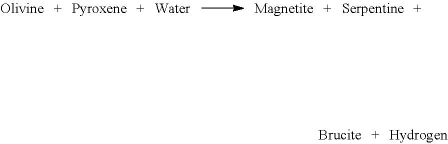

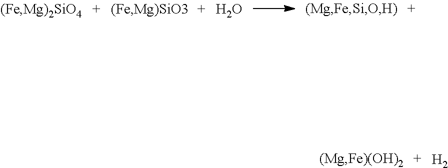

This is a simplified, semi-general, unbalanced equation, but describes a general process. The primary elements involved are Fe, H, Mg, O, and Si. There are secondary elements that may enter the chemical processes, such as Ca and Ni, but they may not be central to the primary reaction. The relative elemental outputs may be sufficient for determining if the requisite elements may be present for hydrogen generation, but they may not be sufficient to distinguish between reactants and products. In order to overcome this, additional data may be used. In block 1008, supplementary data such as bulk density, formation Pe (photoelectric factor), and thermal neutron porosity may be acquired or obtained in any form whether via downhole operations or any other means. The closure and mineralogy models may be supplemented with formation sigma, determined above (macroscopic thermal neutron capture cross section) the formation bulk density, and formation Pe (photoelectric factor), and the thermal neutron porosity data from block 1008. The closure method for sedimentary rocks may be used to convert relative elemental yields to elemental weight fractions. It was originally developed for capture spectroscopy, which didn't directly measure elements that comprised a significant weight fraction of the formation, such as carbon and oxygen. This is expressed by equation (1):

$$F [ {\sum }_{i} {X}_{i} \frac{{Y}_{i}}{{S}_{i}} ] = 1 \qquad ( 1 )$$

where, for element i, Yᵢ is the relative yield, Sᵢ is the sensitivity factor, Xᵢ is the oxide factor, and F is a depth-specific normalization factor. The equation may be keyed to either capture or inelastic. In examples, relative yield Yᵢ may be from spectral decomposition of the capture or inelastic spectrum. Usually, the oxides closure is defined in terms of the capture yields, with the inelastic yields being directly converted to weight fractions or included as other terms in the oxides closure model. Usually, it is keyed to capture, since it provides a more complete set of elements and may be supplemented with inputs derived from inelastic outputs, such as weight fractions directly derived from inelastic yields. This may be done for elements with small capture cross-sections, such as Mg, see equation (2) below. This equation may be supplemented with weight fractions acquired from different methods, such as from inelastic spectra, natural gamma spectroscopy, etc. Since these may be independently normalized, in equation (2):

$$F [ {\sum }_{i} {X}_{i} \frac{{Y}_{i}}{{S}_{i}} ] + {\sum }_{j} {X}_{j} {W}_{j} = 1 \qquad ( 2 )$$

where, for element j, Xⱼ is the oxide factor from table 2 and Wⱼ is the weight fraction. In examples, Weight fraction Wⱼ may be the relative elemental weight fraction of that element in the formation. It may be derived via any method, comprising a function of the inelastic yields, a linear transformation for example. Referring to the chemical equation above, the typical minerals involved in the generation of geologic hydrogen are shown in Table 1 and the associate oxide factors shown in Table 2. Note that each element occupies a single term in Equation (2), but the oxide factors for each element may vary, depending on the mineral species present. The relative elemental yields alone, whether from inelastic or capture spectroscopy, do not provide enough information to uniquely identify the minerals present. Therefore, porosity, bulk density ρₖ, and photoelectric factor Pₑ may be introduced in order to identify the minerals present. The porosity is the formation volume fraction occupied by material other than the rock matrix (i.e. fluid volume). The bulk density ρ is the composite measured density of the rock matrix and pore space fluids. The photoelectric factor Pₑ is a function of the atomic number of the elements composing the rock matrix and pore fluids. The bulk density ρ and photoelectric factor Pₑ may be expanded as

$$ρ = {\sum }_{k} {v}_{k} {ρ}_{k} \qquad ( 3 )$$

$${P}_{e} = \frac{{\sum }_{k} {v}_{k} {ρ}_{e} {P}_{e , k}}{{\sum }_{k} {v}_{k} {P}_{e , k}} \qquad ( 4 a )$$

$${P}_{e} = {\sum }_{i} {w}_{i} {P}_{e , i} \qquad ( 4 b )$$

where, vₖ is the volume fraction, and P_{e,k} is the photoelectric factor for compound k and wᵢ is weight fraction for element i. In examples, photoelectric factor for compound k P_{e,k} may be derived from the photoelectric factor of the constituent elements. The photoelectric factor for an element is fixed, since it is based on the atomic number of that element.

The volume fractions may be derived using a combination of the thermal neutron porosity and the density porosity measurements, which may be referred to as porosity measurements from block 1008. The porosity measurement is keyed to either limestone, sandstone, or dolomite. A unique characterization must be performed to key to a lithology class or mineralogy such as those in Tables 1 and 2, or a unique interpretation scheme much be derived in order to convert the conventional porosity to one that is accurate in the target lithologies/mineralogy. Similarly, the density measurement specification maximum is around 3.0 g/cc, and the photoelectric factor Pe specification maximum is around 10, in examples, these measurements may be made downhole. Table 1 shows that the target formation properties may exceed these values, such that synonymous characterization or interpretation schemes will need to be derived and employed. A composite porosity and saturation model may then be derived. Using the relative behavior of the thermal neutron porosity and the density porosity to determine if the porosity is liquid filled, or gas filled. In the presence of gas, the thermal neutron porosity drops lower than the density porosity (assumed to be water filled) due to the lack of thermalizing hydrogen. Workflow 1000 is effective but may be adapted accordingly, since the lime/sand/dolo assumptions no longer apply. Either the rock matrix density may be estimated from the above, or an iterative optimization may need to be employed.

Then, the information from the inelastic elemental yield, capture inelastic yield, porosity, bulk density ρₖ, and photoelectric factor Pₑ may be used to estimate the relative concentrations of the minerals listed in Tables 1 and 2. A modified form of Equation (2) may be written as

$$F [ {\sum }_{i} {\overline{X}}_{i} \frac{{Y}_{i}}{{S}_{i}} ] + {\sum }_{j} {\overline{X}}_{j} {W}_{j} = 1 \qquad ( 5 )$$

where X̅ are composite oxide factors that are composed of combinations of the oxide factors listed in Table 2. For example,

$${\overline{X}}_{Fe} = {aX}_{Fe , Fayalite} + {bX}_{Fe , Ferosilite} + {bX}_{Fe , Magnetite} \qquad ( 6 )$$

where a, b, and c are weighting constants proportional to the relative concentrations of the minerals. The tables below are not meant to be illustrative rather than comprehensive. With the oxide factors known, the weight fractions of each element may be computed.

From block 1006, one or more output blocks may be created. In examples, the closure model assumes that the elements may be present in a set of compounds and expresses this as a linear combination of elemental terms. Oxide factor Xⱼ accounts for the allocation to the compounds containing that element. These outputs, combined with stoichiometry, may inform the models as to the structure and proportions of each of the reactants and products. A downstream answer product that may be computed with water and gas saturations. Existing methods may be leveraged, supplemented with the above mineralogy information, as necessary. For example, in block 1010, fluid saturations and updated porosity may be calculated. The elemental weight fractions may be input into a mineral model that outputs mineral weight fractions. These may be used to compute a matrix density. The density of the rock. Sigma and elemental indicators may be used to determine fluid types and proportions (saturations). Then the bulk density of the formation (fluid in pore space+matrix) and saturations are used to determine a more accurate porosity. This whole process can be constrained by the thermal neutron porosity, such that, if an iterative procedure is used, it will converge faster.

Then, they may be allocated to minerals using a mineral model that incorporates geochemistry, and the relative concentrations derived above. The fluid saturations may be updated using a refined matrix density computed from the elemental weight fractions.

TABLE 1

| Mineral | Oxide | Density | Pe |
|---|---|---|---|
| Forsterite (Olivine) | Mg2SiO4 | 4.390 | 17.171 |
| Fayalite (Olivine) | Fe2SiO4 | 3.275 | 1.537 |
| Enstatite (Pyroxene) | Mg2(SiO3)2 | 3.950 | 13.570 |
| Ferrosilite (Pyroxene) | Fe2(SiO3)2 | 3.200 | 1.618 |
| Magnetite | Fe3O4 | 5.175 | 22.241 |
| Chrysotile (Serpentine) | Mg3Si2O5(OH)4 | 2.530 | 1.398 |
| Brucite | Mg(OH)2 | 2.390 | 1.010 |

TABLE 2

| Mineral | Formula | Fe | Mg | Si |
|---|---|---|---|---|
| Forsterite (Olivine) | Mg2SiO4 | — | 5.789 | 5.009 |
| Fayalite (Olivine) | Fe2SiO4 | 3.649 | — | 7.255 |
| Enstatite (Pyroxene) | Mg2(SiO3)2 | — | 8.261 | 7.149 |
| Ferrosilite (Pyroxene) | Fe2(SiO3)2 | 4.725 | — | 9.394 |
| Magnetite | Fe3O4 | 4.146 | — | — |
| Chrysotile (Serpentine) | Mg3Si2O5(OH)4 | — | 11.401 | 9.867 |
| Brucite | Mg(OH)2 | — | 2.399 | — |

In block 1012, a minerology model may be created, and a mineral weight fraction may be calculated. In examples, the minerology model converts the element weight fractions to mineral weight fractions by assigning the elements to specific minerals. This may be done with any method, one being a deterministic model that assigns elements to specific minerals in a sequential process. Stoichiometry guides the process, such that residual number of elements are fed to subsequent steps. Additionally, in block 1014, a source rock quality figure of merit (FOM) may be formed. An FOM (or series of FOMs) may indicate the quality and/or capacity of source rock for geologic hydrogen production. The capacity may be governed by how much of the reactant side of the equation is present and the quality of the source rock is indicated by which of the reactants is present and if the conditions are optimized for geologic hydrogen production. For example, if olivine and pyroxene are relatively more abundant to magnetite, serpentine, and brucite, then this is a more favorable capacity relative to the alternative. For the composite reaction listed above, the most favorable subset reaction for producing hydrogen is the conversion of Fayalite to Magnetite in the presence of water. Therefore, a quality figure of merit would evaluate the ratio of Fe to Mg. Another quality (FOM) may comprise the pressure and temperature, since these control the reaction rate. Furthermore, a quality figure of merit could include water saturation, since water is required for the hydrogen production reaction to occur. Once the weight fractions of the elements and minerals are known, the capacity (or quality) of the source rock may be evaluated. The following items may be included in the assessment, relative amount of olivine, quality of olivine (Fe to Mg ratio or Fayalite to Forsterite ratio), water saturation, formation temperature, and/or formation pressure.

In other examples, an analysis of the reactant/product minerals that are inefficiently produce hydrogen, or minerals that react and produce no hydrogen may be kept. For monitoring, the time-variation of the ratio of magnetite to olivine may inform of reservoir productivity.

The methods and systems described above are an improvement over the conventional technology as the methods and systems described herein. Specifically, the answer products are specifically designed for geologic hydrogen formation evaluation and monitoring, rather than their existing oil and gas workflows. Our competitors do not commercially offer these answer products.

As it is impracticable to disclose every conceivable embodiment of the technology described herein, the figures, examples, and description provided herein disclose only a limited number of potential embodiments. One of ordinary skill in the art would appreciate that any number of potential variations or modifications may be made to the explicitly disclosed embodiments, and that such alternative embodiments remain within the scope of the broader technology. Accordingly, the scope should be limited only by the attached claims. Further, the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces. Certain technical details, known to those of ordinary skill in the art, may be omitted for brevity and to avoid cluttering the description of the novel aspects.

For further brevity, descriptions of similarly named components may be omitted if a description of that similarly named component exists elsewhere in the application. Accordingly, any component described with respect to a specific figure may be equivalent to one or more similarly named components shown or described in any other figure, and each component incorporates the description of every similarly named component provided in the application (unless explicitly noted otherwise). A description of any component is to be interpreted as an optional embodiment—which may be implemented in addition to, in conjunction with, or in place of an embodiment of a similarly-named component described for any other figure.

As used herein, adjective ordinal numbers (e.g., first, second, third, etc.) are used to distinguish between elements and do not create any particular ordering of the elements. As an example, a “first element” is distinct from a “second element”, but the “first element” may come after (or before) the “second element” in an ordering of elements. Accordingly, an order of elements exists only if ordered terminology is expressly provided (e.g., “before”, “between”, “after”, etc.) or a type of “order” is expressly provided (e.g., “chronological”, “alphabetical”, “by size”, etc.). Further, use of ordinal numbers does not preclude the existence of other elements. As an example, a “table with a first leg and a second leg” is any table with two or more legs (e.g., two legs, five legs, thirteen legs, etc.). A maximum quantity of elements exists only if express language is used to limit the upper bound (e.g., “two or fewer”, “exactly five”, “nine to twenty”, etc.). Similarly, singular use of an ordinal number does not imply the existence of another element. As an example, a “first threshold” may be the only threshold and therefore does not necessitate the existence of a “second threshold”.

As used herein, the word “data” may be used as an “uncountable” singular noun—not as the plural form of the singular noun “datum”. Accordingly, throughout the application, “data” is generally paired with a singular verb (e.g., “the data is modified”). However, “data” is not redefined to mean a single bit of digital information. Rather, as used herein, “data” means any one or more bit(s) of digital information that are grouped together (physically or logically). Further, “data” may be used as a plural noun if context provides the existence of multiple “data” (e.g., “the two data are combined”).

As used herein, the term “operative connection” (or “operatively connected”) means the direct or indirect connection between devices that allows for interaction in some way (e.g., via the exchange of information). For example, the phrase ‘operatively connected’ may refer to a direct connection (e.g., a direct wired or wireless connection between devices) or an indirect connection (e.g., multiple wired and/or wireless connections between any number of other devices connecting the operatively connected devices).
Statement 1. A method of deploying a pulsed neutron logging tool, comprising: lowering the pulsed neutron logging tool into a borehole in a subterranean formation; detecting natural gamma rays from the subterranean formation via one or more detectors of the pulsed neutron logging tool; broadcasting neutrons into the subterranean formation via a pulsed neutron generator of the pulsed neutron logging tool; detecting one or more neutron-induced gamma rays and the natural gamma rays from the subterranean formation via the one or more detectors; and identifying a porosity, a mineral weight fraction, or a quality figure of merit from based at least on the one or more neutron-induced gamma rays, the natural gamma rays, and a spectrum.
Statement 2. The method of statement 1, wherein the spectrum is an inelastic spectrum or a capture spectrum and creating the inelastic spectrum or the capture spectrum from the natural gamma rays or the neutron-induced gamma rays.
Statement 3. The method of statement 2, further comprising forming an inelastic yields, a capture elemental yields, or a formation sigma form the inelastic spectrum, the capture spectrum, or a capture time decay.
Statement 4. The method of statement 3, further comprising creating a closure model from the inelastic yields, the capture elemental yields, or the formation sigma.
Statement 5. The method of statement 4, wherein the closure model quantifies a quality of a geologic hydrogen reservoir.
Statement 6. The method of statement 5, further comprising utilizing supplementary data to form at least part of the closure model.
Statement 7. The method of statement 6, wherein supplementary data comprises porosity, bulk density, and photoelectric factor.
Statement 8. The method of statements 4-7, further comprising calculating and updating porosity with at least the closure model.
Statement 9. The method of statement 8, further comprising creating a minerology model and calculating a weight fraction.
Statement 10. The method of statement 9, further comprising forming a source rock quality figure, wherein the source rock quality figure, wherein the source rock quality figure indicates quality and/or capacity of source rock for geologic hydrogen production.
Statement 11. A system comprising: a pulsed neutron logging tool lowered into a borehole in a subterranean formation, wherein the neutron logging tool is configured to: detect natural gamma rays from the subterranean formation via one or more detectors of the pulsed neutron logging tool;
broadcast neutrons into the subterranean formation via a pulsed neutron generator of the pulsed neutron logging tool; and detect one or more neutron-induced gamma rays and the natural gamma rays from the subterranean formation via the one or more detectors; and an information handling system configured to: identify a porosity, a mineral weight fraction, or a quality figure of merit from based at least on the one or more neutron-induced gamma rays, the natural gamma rays, and a spectrum.
Statement 12. The system of statement 11, wherein the spectrum is an inelastic spectrum or a capture spectrum and creating the inelastic spectrum or the capture spectrum from the natural gamma rays or the neutron-induced gamma rays.
Statement 13. The system of statement 12, wherein the information handling system is configured to form an inelastic yields, a capture elemental yields, or a formation sigma form the inelastic spectrum, the capture spectrum, or a capture time decay.
Statement 14. The system of statement 13, wherein the information handling system is configured to create a closure model from the inelastic yields, the capture elemental yields, or the formation sigma.
Statement 15. The system of statement 14, wherein the closure model quantifies a quality of a geologic hydrogen reservoir.
Statement 16. The system of statement 15, wherein the information handling system is configured to utilize supplementary data to form at least part of the closure model.
Statement 17. The system of statement 16, wherein supplementary data comprises porosity, bulk density, and photoelectric factor.
Statement 18. The system of statements 14-17, wherein the information handling system is configured to calculate and update porosity with at least the closure model.
Statement 19. The system of statement 18, further comprising creating a minerology model and calculating a weight fraction.
Statement 20. The system of statement 19, wherein the information handling system is configured to form a source rock quality figure, wherein the source rock quality figure, wherein the source rock quality figure indicates quality and/or capacity of source rock for geologic hydrogen production.

What is claimed is:

1. A method of deploying a pulsed neutron logging tool, comprising:
lowering the pulsed neutron logging tool into a borehole in a subterranean formation;
detecting natural gamma rays from the subterranean formation via one or more detectors of the pulsed neutron logging tool;
broadcasting neutrons into the subterranean formation via a pulsed neutron generator of the pulsed neutron logging tool;
detecting one or more neutron-induced gamma rays and the natural gamma rays from the subterranean formation via the one or more detectors; and
identifying a porosity, a mineral weight fraction, or a quality figure of merit from based at least on the one or more neutron-induced gamma rays, the natural gamma rays, and a spectrum.

2. The method of claim 1, wherein the spectrum is an inelastic spectrum or a capture spectrum and creating the inelastic spectrum or the capture spectrum from the natural gamma rays or the neutron-induced gamma rays.

3. The method of claim 2, further comprising forming an inelastic yields, a capture elemental yields, or a formation sigma form the inelastic spectrum, the capture spectrum, or a capture time decay.

4. The method of claim 3, further comprising creating a closure model from the inelastic yields, the capture elemental yields, or the formation sigma.

5. The method of claim 4, wherein the closure model quantifies a quality of a geologic hydrogen reservoir.

6. The method of claim 5, further comprising utilizing supplementary data to form at least part of the closure model.

7. The method of claim 6, wherein supplementary data comprises porosity, bulk density, and photoelectric factor.

8. The method of claim 4, further comprising calculating and updating porosity with at least the closure model.

9. The method of claim 8, further comprising creating a minerology model and calculating a weight fraction.

10. The method of claim 9, further comprising forming a source rock quality figure, wherein the source rock quality figure, wherein the source rock quality figure indicates quality and/or capacity of source rock for geologic hydrogen production.

11. A system comprising:
a pulsed neutron logging tool lowered into a borehole in a subterranean formation, wherein the pulsed neutron logging tool is configured to:
detect natural gamma rays from the subterranean formation via one or more detectors of the pulsed neutron logging tool;
broadcast neutrons into the subterranean formation via a pulsed neutron generator of the pulsed neutron logging tool; and
detect one or more neutron-induced gamma rays and the natural gamma rays from the subterranean formation via the one or more detectors; and
an information handling system configured to:
identify a porosity, a mineral weight fraction, or a quality figure of merit from based at least on the one or more neutron-induced gamma rays, the natural gamma rays, and a spectrum.

12. The system of claim 11, wherein the spectrum is an inelastic spectrum or a capture spectrum and creating the inelastic spectrum or the capture spectrum from the natural gamma rays or the neutron-induced gamma rays.

13. The system of claim 12, wherein the information handling system is configured to form an inelastic yields, a capture elemental yields, or a formation sigma form the inelastic spectrum, the capture spectrum, or a capture time decay.

14. The system of claim 13, wherein the information handling system is configured to create a closure model from the inelastic yields, the capture elemental yields, or the formation sigma.

15. The system of claim 14, wherein the closure model quantifies a quality of a geologic hydrogen reservoir.

16. The system of claim 15, wherein the information handling system is configured to utilize supplementary data to form at least part of the closure model.

17. The system of claim 16, wherein supplementary data comprises porosity, bulk density, and photoelectric factor.

18. The system of claim 14, wherein the information handling system is configured to calculate and update porosity with at least the closure model.

19. The system of claim 18, further comprising creating a minerology model and calculating a weight fraction.

20. The system of claim 19, wherein the information handling system is configured to form a source rock quality figure, wherein the source rock quality figure, wherein the source rock quality figure indicates quality and/or capacity of source rock for geologic hydrogen production.
